(19) United States
(12) Patent Application Publication
(10) Pub. No.: US 2010/0160565 A1
(43) Pub. Date: Jun. 24, 2010

(54) THERMOPLASTIC VULCANIZATE

(75) Inventors: Yao-Tsu Wu, Tainan (TW); Jyh-Horng Wu, Kaohsiung (TW); Yu-Hsin Tsai, Hsinchu (TW)

Correspondence Address: PAI PATENT & TRADEMARK LAW FIRM, 1001 FOURTH AVENUE, SUITE 3200, SEATTLE, WA, 98154, US

(73) Assignee: INDUSTRIAL TECHNOLOGY RESEARCH INSTITUTE, Hsinchu County (TW)

(21) Appl. No.: 12/468,877

(22) Filed: May 20, 2009

(30) Foreign Application Priority Data
Dec. 24, 2008 (TW) 097150379

(51) Int. Cl. C08L 33/02

(52) U.S. Cl. 525/221

(57) ABSTRACT

Thermoplastic vulcanizates are provided. The thermoplastic vulcanizate includes a blend, wherein the blend includes vulcanized acrylic rubber and polyester plastic. The vulcanized acrylic rubber is prepared by reacting an acrylic rubber (ACM) with an epoxy group-containing resin as a vulcanizing agent via dynamic vulcanization.

### CROSS REFERENCE TO RELATED APPLICATIONS

This application is based upon and claims the benefit of priority from the prior Taiwan Patent Application No. 97150379, filed on Dec. 24, 2008, the entire contents of which are incorporated herein by reference.

### BACKGROUND OF THE INVENTION

1. Field of the Invention

The invention relates to a thermoplastic vulcanizate, and more particularly to a thermoplastic vulcanizate prepared in the presence of a specific vulcanizing agent.

2. Description of the Related Art

Thermoplastic vulcanizates are provided. The thermoplastic vulcanizate includes a blend, wherein the blend includes vulcanized acrylic rubber and polyester plastic. The vulcanized acrylic rubber is prepared by having acrylic rubber (ACM) react with an epoxy group-containing resin as a vulcanizing agent via dynamic vulcanization.

A thermoplastic elastomer (TPE) is a novel polymer material that is available. Thermoplastic elastomers have excellent processability, superior elasticity, and low compression sets, as with conventional plastics. Further, hardness of thermoplastic elastomers ranges from between that of conventional rubber and conventional plastic.

Additionally, products made of thermoplastic elastomers are recyclable, unlike conventional rubbers and plastics. Accordingly, thermoplastic elastomers (TPE) have gradually replaced conventional resins in manufacturing of plastic articles (such as sports equipment or automobile parts).

Among the types of thermoplastic elastomers (TPE), increased demand for thermoplastic vulcanizates (TPV) has been seen recently due to its similar characteristics with conventional vulcanization rubber (similar bridgings), superior elasticity and low compression set. TPVs are recyclable, perform well under high temperatures, and are gradually replacing conventional thermoplastic rubbers.

Thermoplastic vulcanizates are generally prepared by blending plastic with rubber via dynamic cross-linking, wherein the vulcanizated rubber particles are distributed among a continuous plastic matrix. The blending results in soft segments of acrylate, saturated structured main chains and polar ester-based side chains. Thus, TPVs exhibit superior elasticity, thermal resistance, ozone aging resistance, and oil resistance, and does not generate smoke or irritant gases when applied. Currently, TPVs have replaced butadiene-acrylonitrile rubber (NBR), in production applications such as high temperature resistant seals of automobiles, high temperature and oil resistant cables (or pipe, belt, chest, etc.), and brittle resin toughening modifiers.

The current method for preparing thermoplastic vulcanizate includes blending rubber and plastic in the presence of a vulcanizing agent and a co-curing agent via dynamic vulcanization cross-linking. The obtained TPV exhibits different characteristics depending on the selection of various rubbers, plastics, and vulcanizing agents/co-curing agents. U.S. Pat. No. 5,942,577 discloses a thermoplastic elastomer which is prepared by bleeding acrylate rubber (ACM) and polyester, polycarbonate, or polyamide (phastic material) in the presence of an amine cure system cross-linking agent and a co-curing agent via dynamic vulcanization.

U.S. Pat. No. 6,140,424 discloses a thermoplastic elastomer prepared by bleeding acrylate rubber (ACM) and Nylon6 (phastic material) in the presence of an amine cure system cross-linking agent and a co-curing agent via dynamic vulcanization.

The thermoplastic elastomers disclosed by the above mentioned prior arts exhibit improved thermal resistance over conventional thermoplastic. However, preserving the amine cure system vulcanizing agent and preventing it from deliquesce is difficult. Further the thermoplastic elastomers do not meet mass production requirements due to the expensive cost of the amine cure system vulcanizing agent. Moreover, it is difficult to precisely control the molar ratio between the vulcanizing agent and the co-curing agent (such as metal oxide, metal hydroxide, or tertiary amine).

U.S. Pat. No. 5,910,543 discloses a thermoplastic elastomer prepared by bleeding acrylate rubber (ACM) and Nylon6 or polybutylene terephalate (plastic material) in the presence of phenolic resin as a vulcanizing agent via dynamic vulcanization. The thermoplastic elastomer, however, has poor mechanical strength.

In order to improve the characteristics of the vulcanizate, U.S. Pat. No. 6,911,103 disclosed a thermoplastic elastomer prepared by bleeding acrylate rubber and polyester, polystyrene, or polyethylene terephthalate (plastic material) in the presence of sulfur compounds as a vulcanizing agent via dynamic vulcanization. In comparison with U.S. Pat. No. 5,910,543, the thermoplastic elastomer has improved mechanical strength but inferior thermal aging resistance. Further, dynamic vulcanization process employing sulfur compounds as a vulcanizing agent results in lower vulcanization efficiency and increased complexity, thus reaction time is increased and yields are reduced.

U.S. Pat. No. 6,815,506 discloses a thermoplastic elastomer prepared by bleeding acrylate rubber and polybutylene terephalate (plastic material) in the presence of a peroxide vulcanizing agent via dynamic vulcanization. Although the thermoplastic elastomer has superior processability, the dynamic vulcanization process employing a peroxide vulcanizing agent results in an increased curing time, thus reducing vulcanization efficiency. Further, the peroxide vulcanizing agent is apt to cause molecular degradation.

Therefore, it is necessary to develop a novel vulcanizing agent, which may be employed in thermoplastic elastomer fabrication, for improving vulcanization efficiency, and simplifying process complexity, wherein the thermoplastic elastomer have characteristics of rubber and plastic materials.

### BRIEF SUMMARY OF THE INVENTION

An exemplary embodiment of a thermoplastic vulcanizate includes a blend, wherein the blend includes vulcanized acrylic rubber and polyester plastic, and the vulcanized acrylic rubber is prepared by having an acrylic rubber react with an epoxy group-containing resin as a vulcanizing agent via dynamic vulcanization.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a SEM (scanning electron microscope) image of the thermoplastic vulcanizate (A) as disclosed in Example 1.

FIG. 2 is a SEM (scanning electron microscope) image of the comparative thermoplastic elastomer (A) as disclosed in Comparative Example 1.

FIG. 3 shows a graph plotting extension against the ACM/PBT weight ratio of Examples 1-3 and Comparative Examples 1-3.

FIG. 4 shows a graph plotting compression set against the ACM/PBT weight ratio of Examples 1, 3, 4, and 7 and Comparative Examples 1 and 3-4.

### DETAILED DESCRIPTION OF THE INVENTION

The invention provides a thermoplastic vulcanizate including a blend, wherein the blend includes vulcanized acrylic rubber and polyester plastic, and the vulcanized acrylic rubber is prepared by reacting an acrylic rubber with an epoxy group-containing resin as a vulcanizing agent via dynamic vulcanization.

In an embodiment, the process for fabricating thermoplastic vulcanizate includes simultaneously adding acrylic rubber, polyester, and epoxy group-containing resin (as a vulcanizing agent) into the feed of a twin screw extruder, wherein the twin screw extruder has a screw diameter of 26 mm and a length/diameter ratio (L/D) of 56. The reaction temperature is about 200-260° C. (according to the processability of the rubber and the plastic used), the extrusion speed is about 200-800 rpm (rotation rate of screw: 120-1200 rpm), and the reaction time is about 1-10 minutes.

Since the acrylic rubber dynamic vulcanization process employs the epoxy group-containing resin as a vulcanizing agent, cross-linking efficiency is enhanced and the vulcanization reaction time is controlled within 2-4 minutes. Further, in another embodiment of the invention, the acrylic rubber and the epoxy group-containing resin can be added into the feed of a twin screw extruder undergoing dynamic vulcanization in advance, and the obtained vulcanized acrylic rubber with a network structure is further blended with and distributed to the polyester plastic via the twin screw extruder. In comparison with the conventional multi-step vulcanization process, the process of the invention reduces process time. The obtained thermoplastic vulcanizate of the invention has an increased elongation proportional to the cross-linking degree and a low compression set of less than 1%. The thermoplastic vulcanizate includes a rubber-plastic blend having a vulcanized acrylic rubber network structure and (physical cross-linking) polyester plastic, constituting an interpenetrating network (IPN), thereby achieving island and sea distribution. The thermoplastic vulcanizate of the invention can serve as a raw material in the manufacturing of automobile parts, such as air pipes, oil pipes, or car lamp packing pieces.

In embodiments of the invention, the acrylic rubber (ACM) can include alkyl acrylate, alkoxy acrylate, copolymer thereof, or combinations thereof, and can be a conventional acrylic rubber copolymer. Particularly, the acrylic rubber can have terminal reactive functional groups (such as an acrylic group, acryloyl group, or amino group) or unsaturated double bond groups.

The epoxy group-containing resin preferably includes at least two epoxy groups, such as novolac epoxy resin, bisphenol A epoxy resin, cyclo aliphatic epoxy resin, or brominated epoxy resin, such as phenolic novolac epoxy resin, cresol novolac epoxy resin, tetrabromo bisphenol A diglycidyl ether epoxy, naphthalene epoxy resin, diphenylene epoxy resin, dicyclopentadiene epoxy resin, or combinations thereof. In an embodiment of the invention, the novolac epoxy resin can have a structure represented as follows:

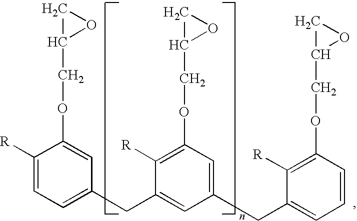

wherein R can be H, alkyl group, or alkoxy group, and n is an integer equal to or greater than 1, such as 1, 2, 3, or 4.

In an embodiment of the invention, the bisphenol A epoxy resin has a structure represented as follows:

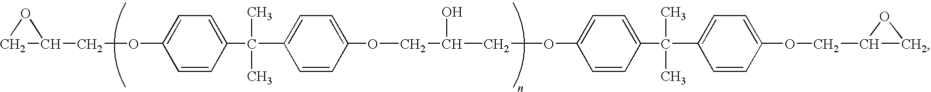

wherein n is equal to or greater than 0.

In an embodiment of the invention, the brominated epoxy resin has a structure represented as follows:

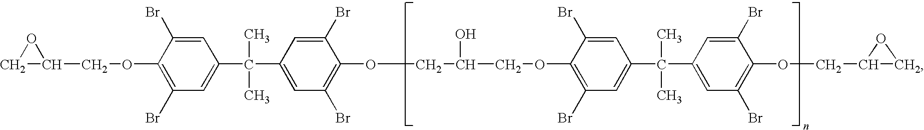

wherein n is equal to or greater than 0.

In embodiments of the invention, the polyester plastic can include polyethylene terephthalate (PET), polybutylene terephthalate (PBT), poly(cyclohexylene dimethylene terephthalate)-Glycol modified polyester (PCTG), polybutylene phthalate, poly(ethylene terephthalate)-Glycol modified polyester (PETG), polycyclohexylenedimethylene terephthalate (PCT), polyethylene terephthalate (PEN), polypropylene terephthalate (PPT), or polytrimethylene terephthalate (PTT). For superior thermal resistance, dimensional stability, and mechanical properties, the polyester plastic preferably includes polybutylene terephthalate (PBT).

In embodiments of the invention, in the process for fabricating the thermoplastic vulcanizate, the weight distribution percentage of the acrylic rubber is about 10-90 wt %, preferably 40-60 wt %, based on the weight of the acrylic rubber and the polyester plastic. Further, in the process for fabricating the thermoplastic vulcanizate, the weight percentage of polymer plastic is 10-90 wt %, preferably 40-60 wt %, based on the weight of the acrylic rubber and the polyester plastic. Moreover, the weight distribution percentage of the epoxy group-containing resin is about 1-10 wt %, preferably 2.5-7.5 wt %, based on the weight of the acrylic rubber.

The following examples are intended to illustrate the invention more fully without limiting the scope, since numerous modifications and variations will be apparent to those skilled in this art.

### Preparation of Thermoplastic Vulcanizates

### Example 1

100 g of ethylene/acrylic elastomer (as acrylic rubber), 100 g of polybutylene terephthalate with the repeat unit:

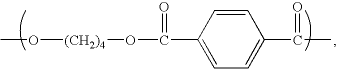

and 5 g of novolac epoxy resin (with the structure of

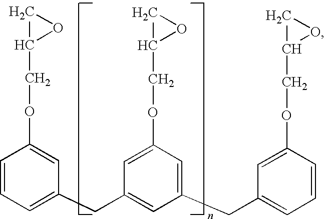

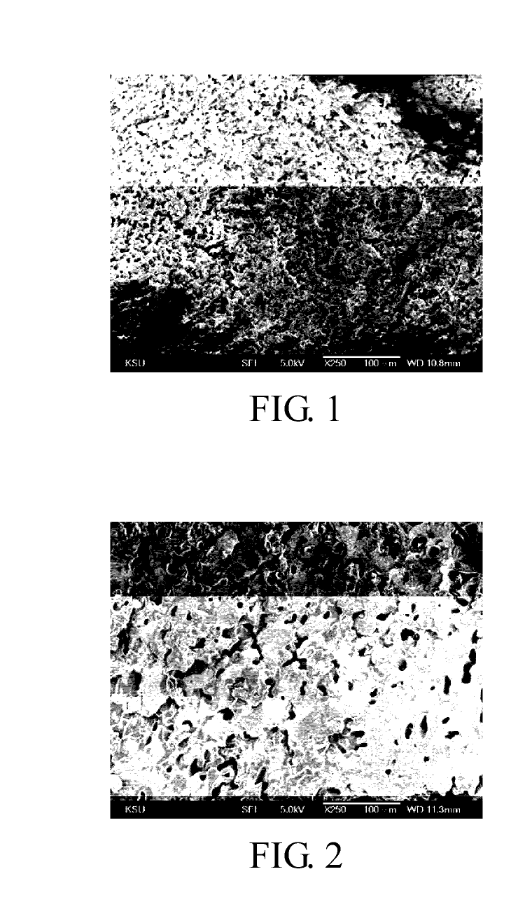

n≧0) were added into the feed of a twin screw extruder to perform a one-step blending process to prepare the thermoplastic vulcanizate (A), wherein the twin screw extruder had a screw diameter of 26 mm and a length/diameter ratio (L/D) of 56. Particularly, the weight ratio between the ethylene/acrylic elastomer and the polybutylene terephthalate was 50:50, and the weight percentage of epoxy group-containing resin was 5 wt %, based on the weight of the ethylene/acrylic elastomer. The reaction temperature was of 220-240° C. (according to the processability of the rubber and the plastic), the extrusion speed was 500 rpm, and the reaction time was 2 minutes. FIG. 1 is a SEM image of the thermoplastic vulcanizate (A). The components and amounts thereof are shown in Table 1.

### Example 2

100 g of ethylene/acrylic elastomer (as acrylic rubber), 81.8 g of polybutylene terephthalate with the repeat unit:

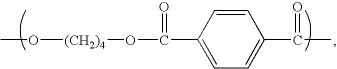

and 5 g of novolac epoxy resin (with the structure of

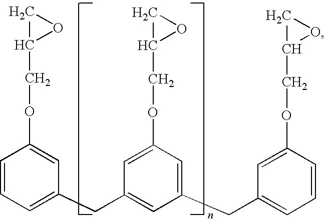

n≧0) were added into the feed of a twin screw extruder to perform a one-step blending process to prepare the thermoplastic vulcanizate (B), wherein the twin screw extruder had a screw diameter of 26 mm and a length/diameter ratio (L/D) of 56. Particularly, the weight ratio between the ethylene/acrylic elastomer and the polybutylene terephthalate was 55:45, and the weight percentage of epoxy group-containing resin was 5 wt %, based on the weight of the ethylene/acrylic elastomer. The reaction temperature was of 220-240° C. (according to the processability of the rubber and the plastic), the extrusion speed was 500 rpm, and the reaction time was 2 minutes. The components and amounts thereof are shown in Table 1.

### Example 3

100 g of ethylene/acrylic elastomer (as acrylic rubber), 66.7 g of polybutylene terephthalate with the repeat unit:

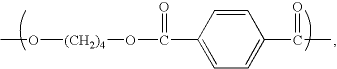

and 5 g of novolac epoxy resin (with the structure of

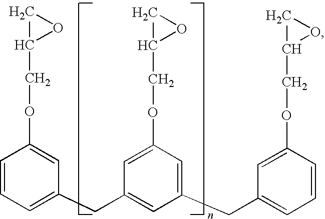

n≧0) were added into the feed of a twin screw extruder to perform a one-step blending process to prepare the thermoplastic vulcanizate (C), wherein the twin screw extruder had a screw diameter of 26 mm and a length/diameter ratio (L/D) of 56. Particularly, the weight ratio between the ethylene/acrylic elastomer and the polybutylene terephthalate was 60:40, and the weight percentage of epoxy group-containing resin was 5 wt %, based on the weight of the ethylene/acrylic elastomer. The reaction temperature was of 220-240° C. (according to the processability of the rubber and the plastic), the extrusion speed was 500 rpm, and the reaction time was 2 minutes. The components and amounts thereof are shown in Table 1.

### Example 4

100 g of ethylene/acrylic elastomer (as acrylic rubber), 150 g of polybutylene terephthalate with the repeat unit:

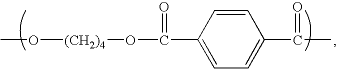

and 5 g of novolac epoxy resin (with the structure of

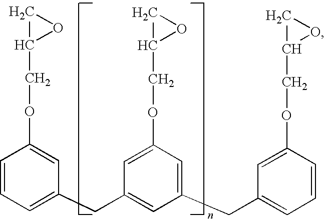

n≧0) were added into the feed of a twin screw extruder to perform a one-step blending process to prepare the thermoplastic vulcanizate (D), wherein the twin screw extruder had a screw diameter of 26 mm and a length/diameter ratio (L/D) of 56. Particularly, the weight ratio between the ethylene/acrylic elastomer and the polybutylene terephthalate was 40:60, and the weight percentage of epoxy group-containing resin was 5 wt %, based on the weight of the ethylene/acrylic elastomer. The reaction temperature was of 220-240° C. (according to the processability of the rubber and the plastic), the extrusion speed was 500 rpm, and the reaction time was 2 minutes. The components and amounts thereof are shown in Table 1.

### Example 5

100 g of ethylene/acrylic elastomer (as acrylic rubber), 100 g of polybutylene terephthalate with the repeat unit:

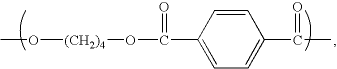

and 7.5 g of novolac epoxy resin (with the structure of

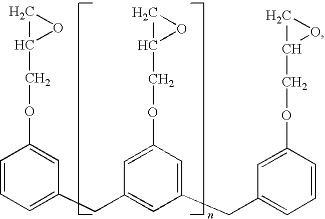

n≧0) were added into the feed of a twin screw extruder to perform a one-step blending process to prepare the thermoplastic vulcanizate (E), wherein the twin screw extruder had a screw diameter of 26 mm and a length/diameter ratio (L/D) of 56. Particularly, the weight ratio between the ethylene/acrylic elastomer and the polybutylene terephthalate was 50:50, and the weight percentage of epoxy group-containing resin was 7.5 wt %, based on the weight of the ethylene/acrylic elastomer. The reaction temperature was of 220-240° C. (according to the processability of the rubber and the plastic), the extrusion speed was 500 rpm, and the reaction time was 2 minutes. The components and amounts thereof are shown in Table 1.

### Example 6

100 g of ethylene/acrylic elastomer (as acrylic rubber), 66.7 g of polybutylene terephthalate with the repeat unit:

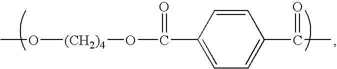

and 7.5 g of novolac epoxy resin (with the structure of

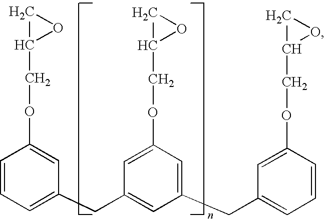

n≧0) were added into the feed of a twin screw extruder to perform a one-step blending process to prepare the thermoplastic vulcanizate (F), wherein the twin screw extruder had a screw diameter of 26 mm and a length/diameter ratio (L/D) of 56. Particularly, the weight ratio between the ethylene/acrylic elastomer and the polybutylene terephthalate was 60:40, and the weight percentage of epoxy group-containing resin was 7.5 wt %, based on the weight of the ethylene/acrylic elastomer. The reaction temperature was of 220-240° C. (according to the processability of the rubber and the plastic), the extrusion speed was 500 rpm, and the reaction time was 2 minutes. The components and amounts thereof are shown in Table 1.

### Example 7

100 g of ethylene/acrylic elastomer (as acrylic rubber), 150 g of polybutylene terephthalate with the repeat unit:

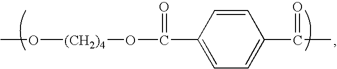

and 7.5 g of novolac epoxy resin (with the structure of

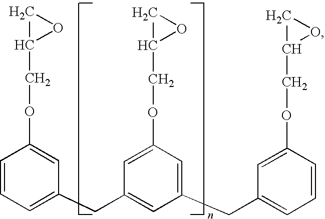

n≧0) were added into the feed of a twin screw extruder to perform a one-step blending process to prepare the thermoplastic vulcanizate (G), wherein the twin screw extruder had a screw diameter of 26 mm and a length/diameter ratio (L/D) of 56. Particularly, the weight ratio between the ethylene/acrylic elastomer and the polybutylene terephthalate was 40:60, and the weight percentage of epoxy group-containing resin was 7.5 wt %, based on the weight of the ethylene/acrylic elastomer. The reaction temperature was of 220-240° C. (according to the processability of the rubber and the plastic), the extrusion speed was 500 rpm, and the reaction time was 2 minutes. The components and amounts thereof are shown in Table 1.

### Comparative Example 1

Comparative Example 1 was performed as Example 1 except that the novolac epoxy resin was absent, obtaining a comparative thermoplastic elastomer (A). The components and amounts thereof are shown in Table 1. FIG. 2 is a SEM image of the comparative thermoplastic elastomer (A).

The preparation of the thermoplastic vulcanizate (A) and the preparation of the comparative thermoplastic elastomer (A) was identical, except for the presence or absence of the novolac epoxy resin. Referring to FIG. 1 and FIG. 2, the rubber phase (soft segment) was more uniformly distributed in the plastic phase (hard segment) for the thermoplastic vulcanizate (A).

### Comparative Example 2

Comparative Example 2 was performed as Example 2 except that the novolac epoxy resin was absent, obtaining a comparative thermoplastic elastomer (B). The components and amounts thereof are shown in Table 1.

### Comparative Example 3

Comparative Example 3 was performed as Example 3 except that the novolac epoxy resin was absent, obtaining a comparative thermoplastic elastomer (C). The components and amounts thereof are shown in Table 1.

### Comparative Example 4

Comparative Example 4 was performed as Example 4 except that the novolac epoxy resin was absent, obtaining a comparative thermoplastic elastomer (D). The components and amounts thereof are shown in Table 1.

TABLE 1

| | | | | weight | |
|---|---|---|---|---|---|
| | | | | percentage of | |
| | ethylene/acrylic | polybutylene | weight | epoxy group- | |
| | elastomer | terephthalate | ratio of | containing | |
| No. | (ACM) | (PBT) | ACM/PBT | resin | |
| Example 1 | 100 g | 100 g | 50:50 | 5 | wt % |
| Example 2 | 100 g | 81.8 g | 55:45 | 5 | wt % |
| Example 3 | 100 g | 66.7 g | 60:40 | 5 | wt % |
| Example 4 | 100 g | 150 g | 40:60 | 5 | wt % |
| Example 5 | 100 g | 100 g | 50:50 | 7.5 | wt % |
| Example 6 | 100 g | 66.7 g | 60:40 | 7.5 | wt % |
| Example 7 | 100 g | 150 g | 40:60 | 7.5 | wt % |
| Comparative | 100 g | 100 g | 50:50 | 0 | |
| Example 1 | | | | | |
| Comparative | 100 g | 81.8 g | 55:45 | 0 | |
| Example 2 | | | | | |
| Comparative | 100 g | 66.7 g | 60:40 | 0 | |
| Example 3 | | | | | |
| Comparative | 100 g | 150 g | 40:60 | 0 | |
| Example 4 | | | | | |

Property Measurements

### Example 8

The Shore D hardness, elongation, and compression set of the thermoplastic vulcanizates (A)-(C) (prepared in Examples 1-3) and the comparative thermoplastic elastomers (A)-(C) were measured, and the results are shown in Table 2. The Shore D hardness” was measured in accordance with the ASTM D-2240, the elongation was measured in accordance with the ASTM D-412 (elongation rate: 500%), and the compression set was measured in accordance with the ASTM D-395 after the samples were subjected to 25% compression for 24 hours at 100° C.

TABLE 2

| | Hardness (Shore | | compression set |
|---|---|---|---|
| | D) | elongation (%) | (%) |
| Example 1 | 36 | 198.9 | 0.03 |
| Example 2 | 23 | 222.3 | 0.21 |
| Example 3 | 22 | 268.89 | 0.23 |
| Comparative | 29 | 139.41 | 44.28 |
| Example 1 | | | |
| Comparative | 17 | 113.88 | 18.13 |
| Example 2 | | | |
| Comparative | 10 | 112.6 | 86.4 |
| Example 3 | | | |

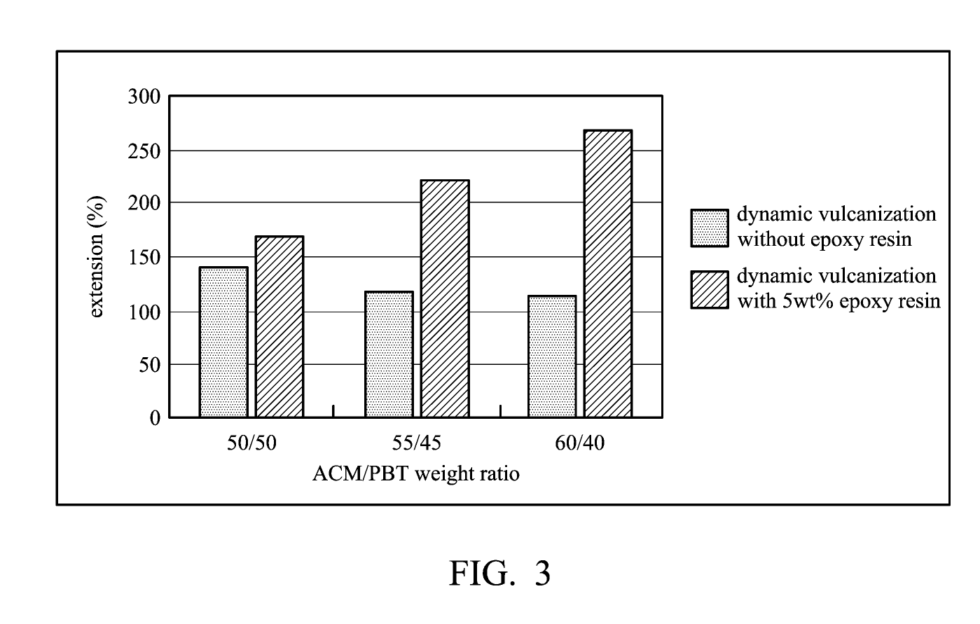

As shown in FIG. 3, the relationship between the glass transition temperature and the weight ratio of PETG/PETS represented a linear trend.

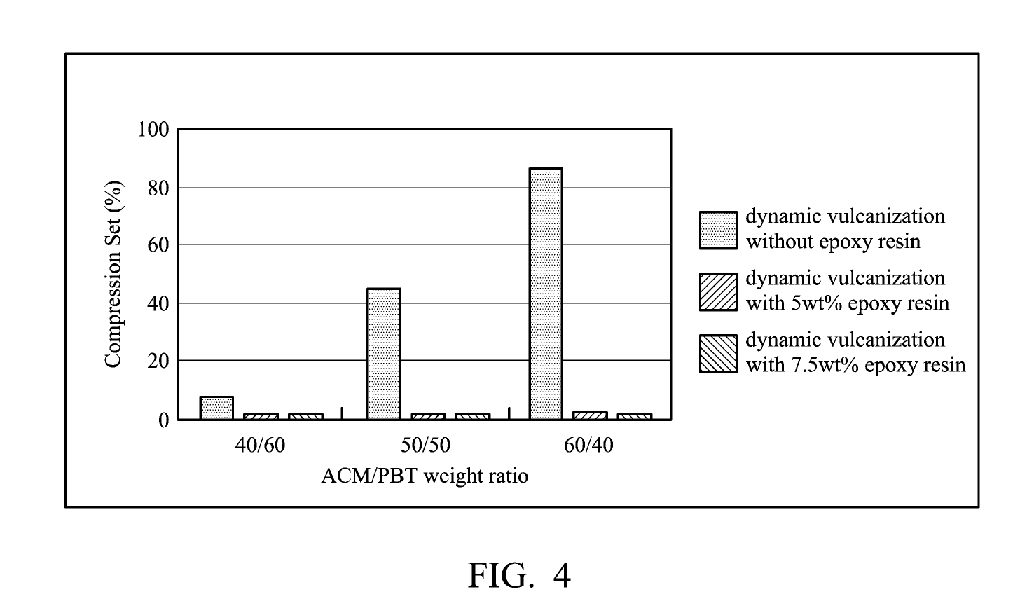

FIG. 3 shows a graph plotting extension against the ACM/PBT weight ratio of dynamic vulcanizations with/without epoxy resin (comparing Example 1 with Comparative Example 1, comparing Example 2 with Comparative Example 2, and comparing Example 3 with Comparative Example 3). FIG. 4 shows a graph plotting compression set against the ACM/PBT weight ratio of dynamic vulcanizations with/without epoxy resin (comparing Examples 1 and 5 with Comparative Example 1, comparing Examples 3 and 6 with Comparative Example 2, and comparing Examples 4 and 7 with Comparative Example 4).

As shown in Table 2 and FIG. 3, the thermoplastic vulcanizates prepared by dynamic vulcanization in the presence of epoxy resin had increased extensions. Further, as shown in Table 2 and FIG. 4, the thermoplastic vulcanizates prepared by dynamic vulcanization in the presence of epoxy resin had reduced compression set of less than 1%.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A thermoplastic vulcanizate, comprising:
a blend, wherein the blend comprises vulcanized acrylic rubber and polyester plastic, wherein the vulcanized acrylic rubber is prepared by reacting an acrylic rubber with an epoxy group-containing resin as a vulcanizing agent via dynamic vulcanization, wherein the epoxy group-containing resin comprises naphthalene epoxy resin or diphenylene epoxy resin.

2. The thermoplastic vulcanizate as claimed in claim 1, wherein the weight distribution percentage of the acrylic rubber is about 10-90wt%, based on the weight of the acrylic rubber and the polyester plastic.

3. The thermoplastic vulcanizate as claimed in claim 1, wherein the weight distribution percentage of the acrylic rubber is about 40-60wt%, based on the weight of the acrylic rubber and the polyester plastic.

4. The thermoplastic vulcanizate as claimed in claim 1, wherein the weight distribution percentage of the polyester plastic is about 10-90wt%, based on the weight of the acrylic rubber and the polyester plastic.

5. The thermoplastic vulcanizate as claimed in claim 1, wherein the weight distribution percentage of the polyester plastic is about 40-60wt%, based on the weight of the acrylic rubber and the polyester plastic.

6. The thermoplastic vulcanizate as claimed in claim 1, wherein the epoxy group-containing resin comprises at least two epoxy groups.

7. The thermoplastic vulcanizate as claimed in claim 1, wherein the vulcanized acrylic rubber has a network structure.

8-14. (canceled)

15. The thermoplastic vulcanizate as claimed in claim 1, wherein the weight distribution percentage of the epoxy group-containing resin is about 1-10wt%, based on the weight of the acrylic rubber.

16. The thermoplastic vulcanizate as claimed in claim 1, wherein the weight distribution percentage of the epoxy group-containing resin is about 2.5-7.5wt%, based on the weight of the acrylic rubber.

17. The thermoplastic vulcanizate as claimed in claim 1, wherein the vulcanized acrylic rubber is prepared by having the acrylic rubber react with an epoxy group-containing resin in the absence of a co-curing agent.

18. The thermoplastic vulcanizate as claimed in claim 1, wherein the acrylic rubber comprises alkyl acrylate, alkoxy acrylate, copolymer thereof, or combinations thereof.

19. The thermoplastic vulcanizate as claimed in claim 1, wherein the polyester plastic comprises polyethylene terephthalate (PET), polybutylene terephthalate (PBT), poly(cyclohexylene dimethylene terephthalate)-Glycol modified polyester (PCTG), polybutylene phthalate , poly(ethylene terephthalate)-Glycol modified polyester (PETG), polycyclohexylenedimethylene terephthalate (PCT), polyethylene terephthalate (PEN), polypropylene terephthalate (PPT), or polytrimethylene terephthalate (PTT).

20. The thermoplastic vulcanizate as claimed in claim 1, wherein the thermoplastic vulcanizate has a compression set of less than 1%.

21. The thermoplastic vulcanizate as claimed in claim 1, wherein the thermoplastic vulcanizate has an interpenetrating network (IPN) structure.

22-23. (canceled)

24. An automobile part, comprising the thermoplastic vulcanizate as claimed in claim 1.

25. The automobile part as claimed in claim 24, wherein the automobile part comprises air pipes, oil pipes, or car lamp packing pieces.
